(19) United States
(12) Patent Application Publication
(10) Pub. No.: US 2004/0205371 A1
(43) Pub. Date: Oct. 14, 2004

(54) Configuration for adjusting CPU speed and method thereof

(76) Inventor: Kun-Hung Huang, Taipei (TW)

Correspondence Address: BIRCH STEWART KOLASCH & BIRCH, PO BOX 747, FALLS CHURCH, VA, 22040-0747, US

(21) Appl. No.: 10/409,180

(22) Filed: Apr. 9, 2003

(51) Int. Cl. G06F 1/04

(52) U.S. Cl. 713/600

(57) ABSTRACT

A configuration for tuning CPU working frequency and method thereof is disclosed, thereby adjusting the working frequency of a CPU of a data processing system at any time. An additional control circuit is not needed. The configuration is composed of firmware and software. When the temperature of the data processing system is too high, the working frequency of the CPU may be adjusted through the configuration and the method of the invention to lower the temperature of the CPU. Meanwhile, when the data processing system enters an idle mode, the frequency of the CPU is also lowered to reduce power consumption.

### BACKGROUND OF THE INVENTION

1. Field of Invention

The invention is related to a configuration for tuning working frequency, and more particularly to a configuration for tuning working frequency of a CPU and method thereof applied in data processing systems.

2. Related Art

With the development of information technology, people use electronic devices more frequently. From governments, enterprises, to households and individuals, people rely on electronic devices more and more. The speed of data processing systems, or computing systems, becomes faster and faster in order to improve convenience and efficiency.

The heart of the data processing system is the central processing unit, or CPU. The CPU is an integrated circuit (IC). It is also a circuit for the system to process internal operations, interface control and data storage. Computing operations, data input and output, and linkage to storage devices in the data processing systems are performed and controlled by the CPU.

A faster CPU is required because the CPU performs more and more operations. The working frequency is also increasing. In the environment of high working frequency, the system is often faced with high-temperature problems. Furthermore, high working frequency often consumes a large amount of power. Regarding the power consumption problem, speed step technology for saving the CPU power has been provided.

However, the speed step technology requires supportable chips, while additional circuits are necessary with unsupportable chips for controlling or adjusting the speed of the CPU.

### SUMMARY OF THE INVENTION

The main object of the invention is to provide a configuration for tuning the CPU working frequency, thereby adjusting the working frequency of the CPU of the data processing system at any time. An additional control circuit is not needed. The configuration of the invention is composed of firmware and software. When the temperature of the data processing system is too high, the working frequency of the CPU may be adjusted through the configuration and the method of the invention to lower the temperature of the CPU. Meanwhile, when the data processing system enters an idle mode, the frequency of the CPU is also lowered to reduce power consumption.

Further scope of applicability of the invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow illustration only, and thus are not limitative of the present invention, and wherein:

FIG. 1 is the block diagram of the circuit for adjusting the CPU working frequency of the invention;

FIG. 2A is the flow chart of the method for adjusting the CPU working frequency of the invention;

FIG. 2B is the flow chart of the method for adjusting the CPU working frequency of the invention; and

FIG. 2C is the flow chart of the method for adjusting the CPU working frequency of the invention.

### DETAILED DESCRIPTION OF THE INVENTION

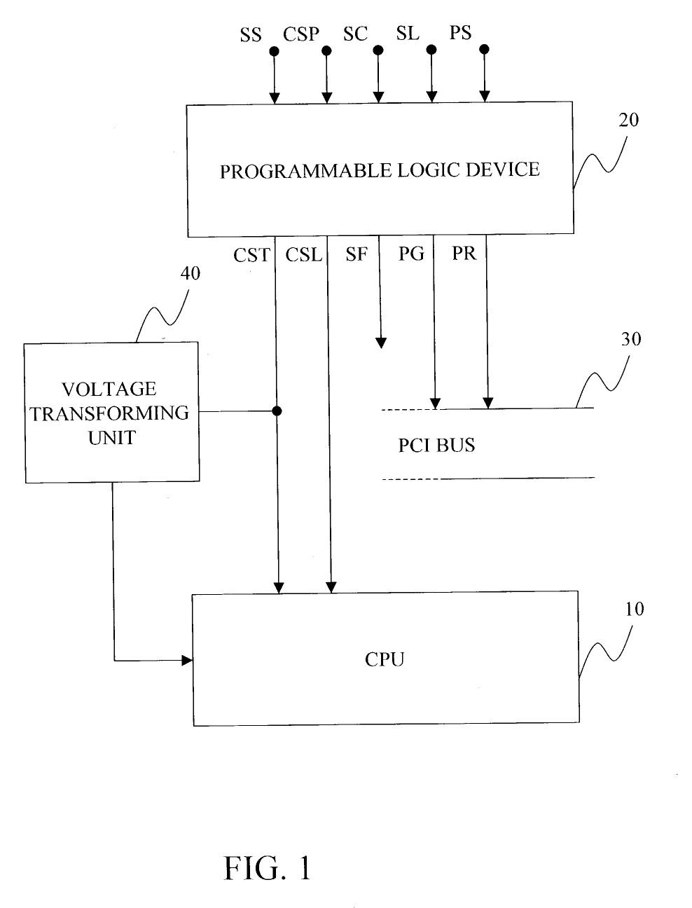

The configuration for adjusting the CPU working frequency and method thereof utilizes firmware and software, and employs ‘system management interrupt (SMI)’ to perform the speed step function. Please refer to FIG. 1, which shows the block diagram of the circuit for adjusting the CPU working frequency of the invention.

The configuration of the invention includes a programmable logic device 20, a peripheral component interconnect (PCI) bus 30 and a voltage-transforming unit 40. The programmable logic device 20 is a Complex Programmable Logic Devices (CPLD). The configuration further involves receiving the following signals: PCI stop signal (PS), service protocol signal (SL), stop-clock signal (SC), CPU speed signal (CSP) and speed step start signal (SS-start). When the programmable logic device 20 receives the speed step start signal, it checks the PCI stop signal sent from the general purpose output (GPO) and the CPU-speed signal (CSP), together with the Service Location Protocol signal (SLP-X, SL) from the south bridge chip and the stop-clock signal (stop-CLK, SC). When the aforesaid four signals are active, the programmable logic device 20 transmits the PCI request signal (PCI-REQ, PR) and the PCI grant signal (PCI-GNT, PG) to the peripheral component interconnect bus (PCI-BUS) 30, thereby making the peripheral component interconnect bus 30 stop working temporary. At the same time, the programmable logic device 20 deliveries the CPU stop-clock signal (CPU stop-CLK, CST) and the CPU service location protocol signal (CPU-SLP, CSL) to the CPU 10. The CSL signal is also transmitted to the voltage-transforming unit 40. The voltage-transforming unit 40 refers to the max/min speed of the CPU to adjust the working frequency, or speed. After adjusting the speed, a speed step finish signal (SS-finish, SF) is sent from the programmable logic device, and the operation of the data processing system is recovered.

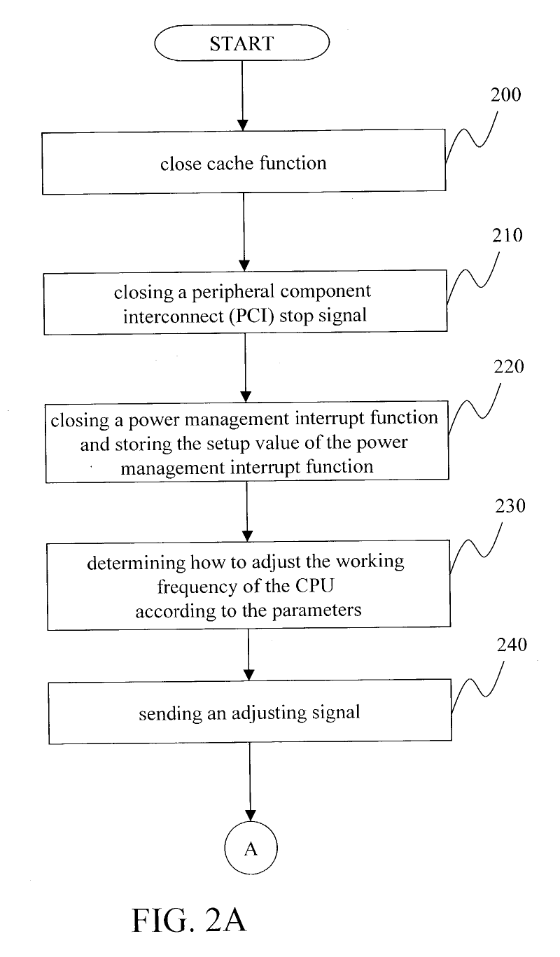

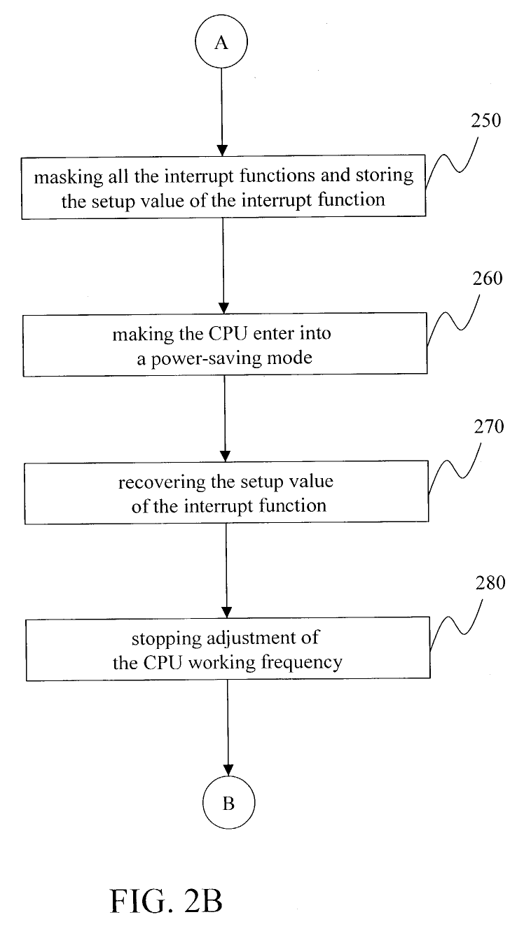

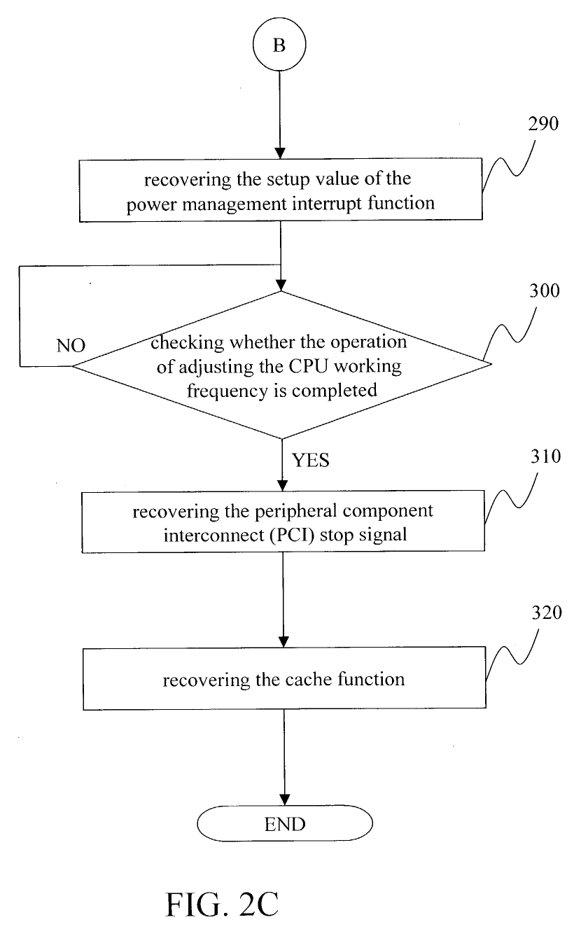

The method of the invention is illustrated in detail as follows. Please refer to FIGS. 2A to 2C, which show the flow chart of the method for adjusting the CPU working frequency of the invention.

Initially, the method involves closing a cache function (Step 2200) and the PCI stop signal simultaneously (Step 210). The power management interrupt function is also closed and the setup value is then stored (Step 220). The degree to which the working frequency needs to be adjusted is determined according to the parameters (Step 230). The parameters include the present condition of the data processing system, and the speed step start signal is delivered accordingly. The preparation for adjusting the working frequency is thus completed.

After the speed step start signal is sent, all the interrupt functions are masked and the setup values of the interrupt functions are stored (Step 250). Then, the CPU enters the power-saving mode (Step 260) and starts to adjust its working frequency, or speed. Step 260 also involves accessing a procedure of a register, and sending the SLP-X signal from the south bridge chip and the stop-CLK signal from the north bridge chip of the data processing system. After completing the above steps, the stored setup values of the interrupt functions are recovered (Step 270), and adjustment of the working frequency of the CPU is stopped (Step 280).

Finally, the setup value of the power management interrupt function is recovered (Step 290). Then comes the step of checking whether the adjusting operation is completed (Step 300). The flows pause until the adjusting operation is completed. After the adjusting operation is completed, the PCI stop signal is recovered (Step 310), and the cache function is also recovered (Step 320). The data processing system then starts to operate normally.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A configuration for adjusting CPU working frequency, which is mounted in a data processing, comprising:
a programmable logic device, which is connected to a central processing unit (CPU) and receives a PCI stop signal (PS), a service location protocol signal (SL), a stop-clock signal (SC), a CPU speed signal (CSP), which is max/min speed of the CPU, and a speed step start signal (SS-start), for checking the PCI stop signal (PS), the service location protocol signal (SL), the stop-clock signal (SC), and the CPU speed signal (CSP) after receiving the speed step start signal (SS-start), transmitting a PCI request signal (PR), a PCI grant signal (PG), a CPU stop-CLK signal, which is transmitted to the CPU, a CPU service location protocol signal (CSL), which is transmitted to the CPU, and transmitting a speed step finish signal (SSF) after the adjusting operation is completed;
a peripheral component interconnect bus (PCI-bus) for receiving the PCI-REQ signal and the PCI-GNT signal, and stopping working during the adjusting period; and
a voltage-transforming unit, which is connected to the programmable logic device, for receiving the CPU service location protocol signal (CSL) and adjusting a working voltage according the operation mode of the CPU.

2. The configuration of claim 1, wherein the programmable logic device is a complex programmable logic device (CPLD).

3. The configuration of claim 1, wherein the PCI stop signal is sent from a general-purpose output (GPO).

4. The configuration of claim 1, wherein the working frequency signal of CPU is sent from a general-purpose output (GPO).

5. The configuration of claim 1, wherein the service protocol signal is sent from a south bridge chip.

6. The configuration of claim 1, wherein the clock stop signal is sent from a north bridge chip.

7. A method for adjusting CPU working frequency, which is mounted in a data processing, comprising the steps of:
closing a cache function;
closing a peripheral component interconnect (PCI) stop signal;
closing a power management interrupt function and storing the setup value of the power management interrupt function;
determining how to adjust the working frequency of CPU according to at least a parameter;
sending a adjusting signal and masking all the interrupt functions and storing the setup value of the interrupt function;
making the CPU enter into a power-saving mode and adjusting the working frequency of CPU;
recovering the setup value of the interrupt function and stopping adjusting the working frequency of CPU;
recovering the setup value of the power management interrupt function and checking the operation of adjusting the working frequency of CPU;
recovering the peripheral component interconnect (PCI) stop signal; and
recovering the cache function.

8. The method of claim 7, wherein the step of closing a peripheral component interconnect (PCI) stop signal further comprises a step of sending a peripheral component interconnect stop signal.

9. The method of claim 7, wherein the step of making the CPU enter into a power-saving mode further comprises the steps of:
accessing a procedure of a register;
sending a service protocol signal from a south bridge chip of the data processing system; and
sending a clock stop signal from a north bridge chip of the data processing system.
